(19) United States
(12) Patent Application Publication
(10) Pub. No.: US 2011/0127775 A1
(43) Pub. Date: Jun. 2, 2011

(54) Airborne Power Generation System With Modular Structural Elements

(76) Inventor: Joeben Bevirt, Santa Cruz, CA (US)

(21) Appl. No.: 12/784,294

(22) Filed: May 20, 2010

Related U.S. Application Data
(60) Provisional application No. 61/179,840, filed on May 20, 2009.
(60) Provisional application No. 61/236,521, filed on Aug. 24, 2009.
(60) Provisional application No. 61/258,177, filed on Nov. 4, 2009.
(60) Provisional application No. 61/267,430, filed on Dec. 7, 2009.

(51) Int. Cl. F03D 9/00; B64C 31/06

(52) U.S. Cl. 290/55; 244/153 R

(57) ABSTRACT

A tethered airborne electrical power generation system which may utilize a strutted frame structure with airfoils built into the frame to keep wind turbine driven generators which are within the structure airborne. The primary rotors utilize the prevailing wind to generate rotational velocity. Electrical power generated is returned to ground using a tether that is also adapted to fasten the flying system to the ground. The flying system is adapted to be able to use electrical energy to provide power to the primary turbines which are used as motors to raise the system from the ground, or mounting support, into the air. The system may then be raised into a prevailing wind and use airfoils in the system to provide lift while the system is tethered to the ground. The motors may then resume operation as turbines for electrical power generation. The system may be somewhat planar in that many turbines may have their rotors substantially in one or more planes or planar regions. The system may also be adapted to be assembled of modular components such that a variety of different numbers of turbines may be flown, yet the system may be substantially constructed from multiple similar members.

### CROSS REFERENCE TO RELATED APPLICATIONS

This application claims priority to U.S. Provisional Patent Application No. 61/179,840 to Bevirt, filed May 20, 2009, which is hereby incorporated by reference in its entirety. This application claims priority to U.S. Provisional Patent Application No. 61/236,521 to Bevirt, filed Aug. 24, 2009, which is hereby incorporated by reference in its entirety. This application claims priority to U.S. Provisional Patent Application No. 61/258,177 to Bevirt, filed Nov. 4, 2009, which is hereby incorporated by reference in its entirety. This application claims priority to U.S. Provisional Patent Application No. 61/267,430 to Bevirt, filed Dec. 7, 2009, which is hereby incorporated by reference in its entirety.

### BACKGROUND

1. Field of the Invention

This invention relates to power generation, and more specifically to airborne wind-based power generation.

2. Description of Related Art

Wind turbines for producing power are typically tower mounted and utilize two or three blades cantilevered out from a central shaft which drives a generator, usually requiring step up gearing due to the low rotational speed of the blades.

Some airborne windmills are known in the art. An example of a balloon supported device is seen in U.S. Pat. No. 4,073,516, to Kling, which discloses a tethered wind driven floating power plant.

The generation of electricity from conventional ground based devices has been under study for some time. However, such ground based electrical generation devices are somewhat hampered by the low power density and extreme variability of natural wind currents (in time and space) at low altitudes. For example, typical average power density at the ground is less than about 0.5 kilowatts per square meter (kW/m²). Higher altitudes offer more promising energy densities.

A few hundred meters above the ground, increased wind currents are commonly found. Moreover, in the upper sections of the Earth's boundary layer (at an altitude of about 1 kilometer), relatively stronger winds can be obtained on a fairly consistent basis. Moreover, when very high altitudes are reached, the jet stream is encountered. This is advantageous because jet stream power densities can average about 10 kW/m². Thus, at higher altitudes wind generated power becomes an economically feasible alternative using existing technologies to generate power on an economically sustainable scale. The apparatuses and methods disclosed here present embodiments that can access high altitude wind currents and use the higher energy densities to produce power.

### SUMMARY

A tethered airborne electrical power generation system which may utilize a strutted frame structure with airfoils built into the frame to keep wind turbine driven electrical generators which are within the structure airborne. The primary rotors utilize the prevailing wind to generate rotational velocity. In some aspects, electrical power generated is returned to ground using a tether that is also adapted to fasten the flying system to the ground.

In some aspects, the flying system is adapted to be able to use electrical energy to provide power to the generators which are used as motors to raise the system from the ground, or mounting support, into the air. The system may then be raised into a prevailing wind and use airfoils in the system to provide lift while the system is tethered to the ground. The motors may then resume operation as generators for electrical power generation.

The system may be somewhat planar in that many turbines may have their rotors substantially in one or more planes or planar regions. The system may also be adapted to be assembled of modular components such that a variety of different numbers of turbines may be flown, yet the system may be substantially constructed from multiple similar members.

### BRIEF DESCRIPTION OF THE DRAWINGS

FIG. 1 is a sketch of a strutted frame structure with a single plane of airfoils according to some embodiments of the present invention.

FIG. 2 is a sketch of a strutted frame structure with two planes of airfoils according to some embodiments of the present invention.

FIG. 2A is a sketch of a side view of a strutted frame structure with two planes of airfoils according to some embodiments of the present invention.

FIG. 3 is a perspective view of a flying strutted frame structure with wind turbine driven generators according to some embodiments of the present invention.

FIG. 4 is a side view of a flying strutted frame structure with wind turbine driven generators according to some embodiments of the present invention.

FIG. 5 is a close up partial view of a flying strutted frame structure with wind turbine driven generators according to some embodiments of the present invention.

FIG. 6 is a sketch of a strutted frame structure on the ground according to some embodiments of the present invention.

FIG. 7 is a sketch of a flying structure according to some embodiments of the present invention.

FIG. 8 is a cross-sectional view of a tether according to some embodiments of the present invention.

FIG. 9 is a cross-sectional view of a tether according to some embodiments of the present invention.

FIG. 10 is a sketch of a tether with a aerodynamic tether sheath according to some embodiments of the present invention.

FIG. 11 is a perspective view of an airborne power generation system according to some embodiments of the present invention.

FIGS. 12A-B are a front and side view, respectively, of a stationary flight profile according to some embodiments of the present invention.

FIGS. 13A-B are a front and side view, respectively, of a cross-wind flying profile according to some embodiments of the present invention.

FIG. 14 is a perspective view of an airborne power generation system with a front canard according to some embodiments of the present invention.

FIG. 15 is a side view of a power generation system on the ground according to some embodiments of the present invention.

FIG. 16 is a front view of a power generation system with a single airfoil according to some embodiments of the present invention.

### DETAILED DESCRIPTION

In some embodiments of the present invention, an airborne power generation system is adapted to be built in varying sizes, and to provide differing levels of power, through the use of a modular design. A strutted frame structure design with airfoil sections as part of the frame structure and with wind driven power generation turbines is adapted to be flown while tethered to a ground station. The tether may be adapted to be the structural attachment to the ground and also the electrical power conduit between the frame structure and the ground. The power generation system may be sized using modular aspects of both the structural and electrical design. In some aspects, the strutted frame structure is planar, and in other aspects the strutted frame structure may have multiple planes of struts and airfoil sections. The power generation system may be launched from the ground using vertical take-off with the assistance of ground power.

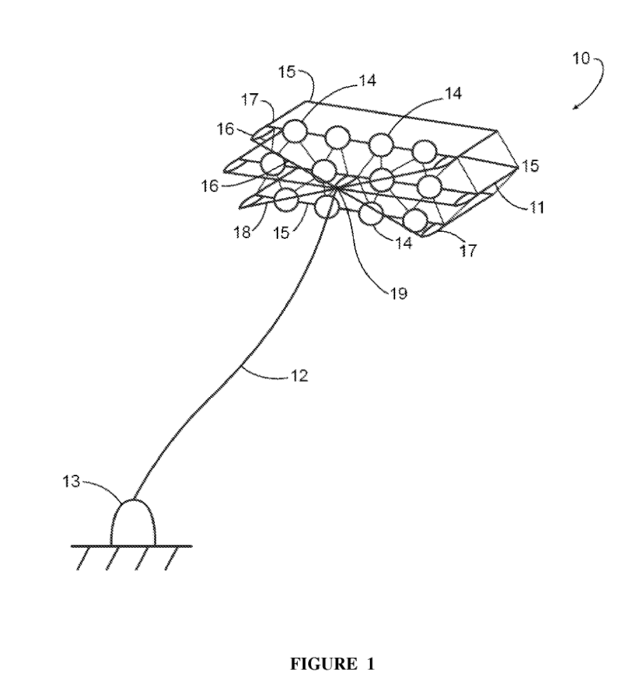

In some embodiments of the present invention, as seen in FIG. 1, an airborne power generation system 10 utilizes a strutted frame structure 11 with wind turbine driven generators 14 arranged in planar frame. The strutted frame structure 11 is attached to a ground station 13 using a tether 12 which may be attached to one or more central pylons 19 or other structural members. The frame structure 11 has rows of airfoil sections 15 which are used in the horizontal positions within the frame. The airfoils sections may all be of the same size and construction. Wind turbine driven generators 14 may be placed at most of the junctions of the airfoil sections 15. Support pylons 17 may also be placed at some junctions of the airfoil sections, and at the ends of the airfoil sections. The support pylons are adapted to support guy wires 18 which may run from one or more inner pylons to the outer pylons, and which are adapted to add structural strength and stiffness to the frame structure under load. In some aspects, the support pylons may extend both forward and rearward from the airfoil sections, allowing for the use support guy wires both in front of and rearward of the airfoil sections. Cross supports 16 run from a junction between two airfoil sections of one row to the junction between two airfoil sections of the row above and/or below that row.

In some embodiments, significant cost savings and ease of construction are achieved wherein most or all of the related structural pieces are identical or nearly identical to each other, allowing for great savings in design and manufacturing costs. For example, each of the airfoil sections may be identical. This allows for modularity in design in that systems of different sizes may be used without redesign of the airfoil sections, and without the associated costs of multiple manufacturing lines. As the airfoil sections may connect to different components at their ends, such as wind turbine driven generators or support pylons, different end fittings may be used as connections depending upon the location in the frame structure. An airfoil section end fitting which connects along the perimeter of the frame structure will have a different number of connections than does an end fitting along the interior of the frame, for example. Most or all of the cross supports may also be identical to each other. In addition to the design cost savings and the manufacturing cost savings, the use of smaller, modular pieces in the strutted frame structure allows for cost reductions in shipping. For example, the major components, each of which may be repeatedly used in the assembly of a frame structure, may be small enough such that they are easily fit into standard cargo containers.

Each of the wind turbine driven generators may be identical. With the use of many wind turbine driven generators, system reliability is enhanced in that the failure of a single generator may not interfere with the power generation capability of other generators. Thus, in the case of an airborne system, the loss of functionality of a single wind turbine driven generator would not necessitate the grounding of the system. The frame structure may be designed against the power capability design needs such that varying amounts of redundancy are designed in, allowing for some wind turbine driven generators to fail and still have adequate system capability.

The airborne power generation system 10 is adapted to fly in a stationary position in winds aloft, or to engage in a cross-wind flying paradigm, or other flying method. The airfoil sections are adapted to provide sufficient lift such that the frame structure 11 is able to maintain itself aloft while generating power. The support pylons and guy wires are adapted to enhance the strength and stiffness of the frame structure. The frame structure, which consists of the cross supports and airfoil sections, is essentially a single plane of structure in some embodiments, wherein the leading edges of the airfoils are all in plane with each other.

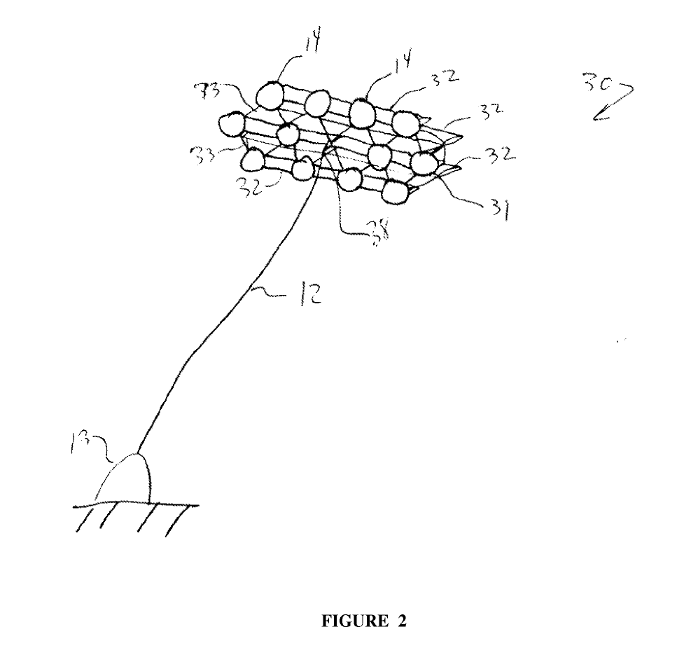

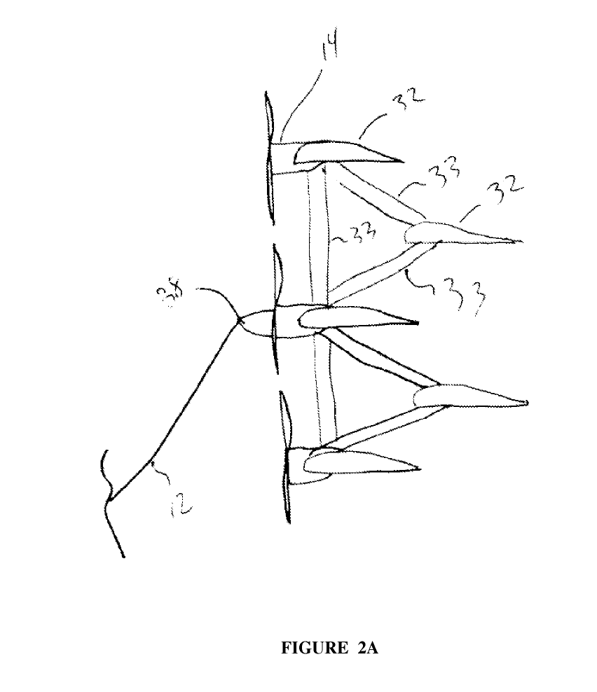

In some embodiments of the present invention, as seen in FIGS. 2 and 2A, an airborne power generation system 30 utilizes a strutted frame structure 31 with wind turbine driven generators 14 arranged in multi-planar frame. The strutted frame structure 31 is attached to a ground station 13 using a tether 12 which may be attached to a central pylon 38. The frame structure 31 has rows of airfoil sections 32 which are used in the horizontal positions within the frame. The airfoils sections may all be of the same construction. Wind turbine driven generators 14 may be placed at most of the junctions of the airfoil sections 32. A first plane of airfoil sections has the leading edges of the airfoils in the same plane, as seen in FIG. 2A. A second plane of airfoil sections has the leading edges of the airfoil section at a plane behind and parallel to the first plane of airfoil sections. Cross supports 33 run from a junction between two airfoil sections of one row to the junction between two airfoil sections of the row above and/or below that row. The cross supports 33 are also run from the junction between two airfoils in the first plane to the junction between two airfoils in the second plane.

The use of a second plane of airfoils behind the first plane of airfoils brings a variety of advantages. One advantage is the stability of the flight of the two plane strutted frame structure. Another advantage is that the strength and rigidity of the structure added by the second plane of airfoils and cross supports may eliminate the need for support guy wires, which also allows more junctions between airfoil sections in the front plane of airfoils to be available for power generation turbines. Another advantage of the second plane of airfoils is the added lift generated by the additional airfoil sections.

The strutted frame structure 31 of the multi-planar airborne power generation system 30 may utilize the same modular airfoil segments 32 in both the front plane and the back plane of the structure. In addition, the cross supports 33 which interlink the front plane airfoil segments may be identical to the cross supports which interlink the rear plane airfoil segments, and be identical to the cross supports which interlink the front plane and the rear plane segments. With the repeated use of identical wind turbine driven generators in the front plane, and the repeated use of identical airfoil segments in the front plane and the rear plane, and the repeated use of identical cross supports throughout the structure, a modularity of design is achieved which allows for customization of sizing of individual systems as well as significant cost savings.

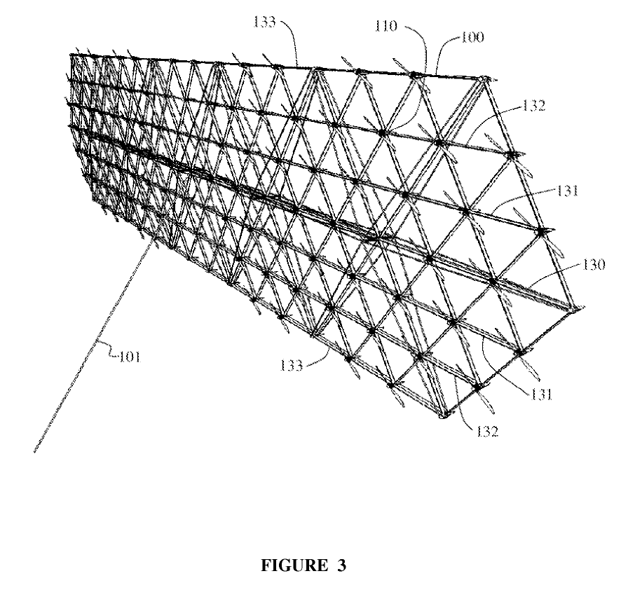

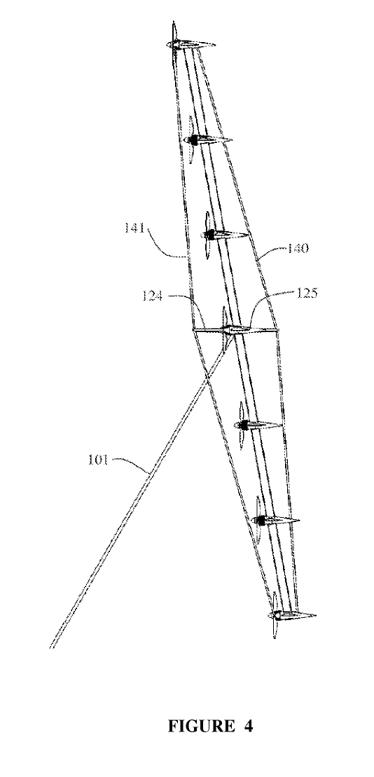

FIGS. 3, 4, and 5 illustrate an embodiment of the present invention wherein a power generation system utilizes a large single plane strutted frame structure 100 shown as may be seen when airborne and constrained by a tether 101. In this illustrative example, the middle row 130 is wider than the rows of airfoils above and below 131, 132, 133, with each row successively shorter by the span of one airfoil segment. Support pylons 124, 125 face forward and rearward for use with front support guy wires 141 and rear support guy wires 140. The support guy wires enhance strength and stiffness of the strutted frame structure.

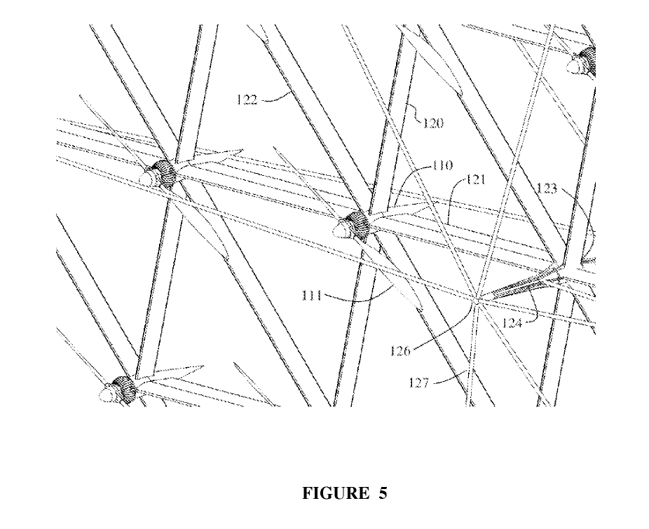

As seen in FIG. 5, the horizontal sections 121 of the frame structure are airfoil elements. The cross struts 120, 122 are utilized to form equilateral triangle subsections of the frame structure in some embodiments. Wind turbine driven generators 110 are placed at most of the junctions of the airfoils and cross struts, although support pylons 123, 124 are used at some locations. The support guy wires 127 may link at a guy wire junction 126 and be routed to and attached to various locations depending upon the specific size and geometry of a particular modular design.

In some embodiments of the present invention, when the flying is in horizontal flight the leading edges of the different rows of airfoil segments may be staggered. In some embodiments, the rows of airfoil segments may be used to create a swept back wing shape.

In some embodiments, the wind turbine driven generators may utilize blades which are pitch controllable. The blade pitch may be controlled with mechanisms at the hub into which the blades are attached. The blade pitch control may allow the blade pitch to be adjusted to allow for better efficiencies depending upon the apparent wind speed at the turbine, as well as limiting rotor speed in high speed winds. The blade pitch control may also allow the drag of a turbine to be altered to allow for attitude control of the strutted frame structure using differential control of the drag of turbines throughout the structure.

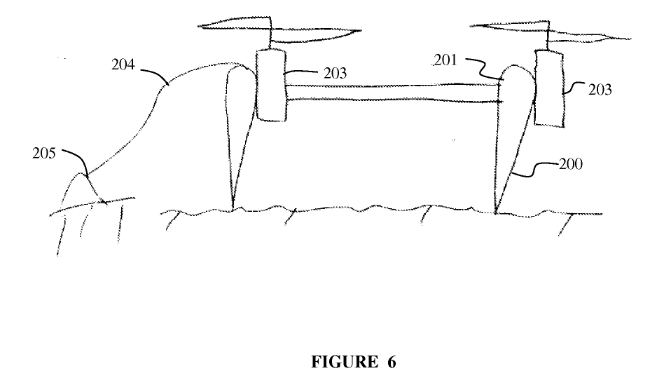

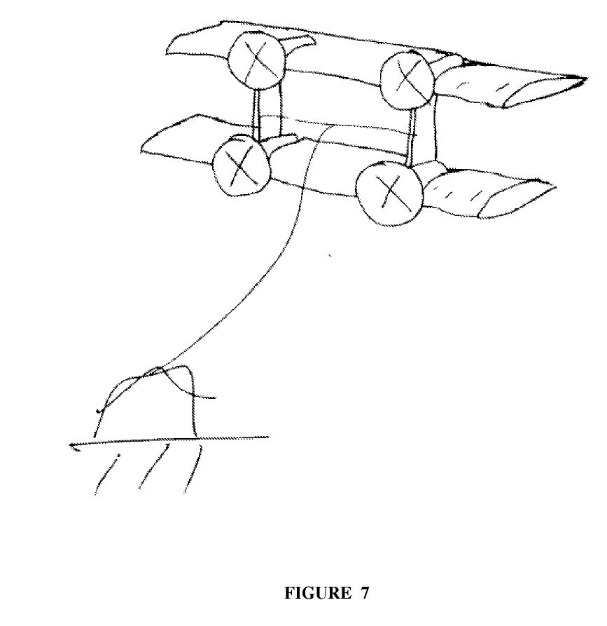

FIGS. 6 and 7 illustrate the vertical take-off aspect of the power generation system. In some embodiments, the frame structure 200 is adapted to rest on the ground, or on a support structure, or float on water such that the front of the airfoil sections 201 is facing skyward and the power generation turbines 203 are also facing skywards. In some embodiments, the electrical portion of the system is adapted to receive power via the tether 204 from the ground station 205 and use that power the turbines as engines. The engines can thus raise the strutted frame structure from the ground into the air. The control system may be adapted to first raise the frame structure in a horizontal position and then the frame may be moved to a vertical position, resulting in a tethered position and flying based upon lift of the airfoils. The vertical take-off scenarios are used with single and multi-plane systems. Unlike traditional VTOL systems for aircraft, the multiple rotors (four as seen if FIGS. 6 and 7) allow for a 2 dimensional spacing of the rotors, greatly enhancing the safety and controllability of the system during takeoff and landing. With the rotors spaced in two-dimensions relative to the plane of the ground, differentiation of thrust between the rotors allows for two-axis control of the structure during take-off and landing. The wind turbine driven generators may operate as motor driven propellers during this aspect. In some embodiments, electrical power to power the motors during take-off and landing travels via the tether from the ground station. In some embodiments, the electrical power to power the motors during take-off and landing may come from a battery storage system on the structure itself.

In some embodiments of the present invention, attitude adjustments of the frame structure may be achieved using differential control of the wind turbine driven generators. For example, to increase the angle of attack of the airfoils within the frame structure, the drag on the upper portion of the structure may be increased, and the drag on the lower part of the structure may be decreased, resulting in a “tilt”, or pitching up, of the frame structure. The changes in drag may be due to changing the loading on the power generation turbines such that the turbine rotational speed is lessened or raised. In addition, the attitude of the frame in general may be controlled using this differential control of the various turbines, which in turn allows for position control relative to wind direction, as well as altitude control.

In the case of cross-wind flying paths, or other flying scenarios of the structure, attitude control and position control are used to implement path control of the flying structure. As mentioned above, pitch and yaw control of the structure may be implemented by varying the amount of drag of individual wind turbine driven generators. In some control scenarios, positive thrust may be used at one or more generators (which then become thrusting motors).

In some embodiments, attitude and altitude control may utilize control surfaces on the airfoils or otherwise mounted within the strutted frame structure. In some embodiments, a full sensor system, or portions thereof, resides on the frame structure. Sensors may include altitude sensors, attitude sensors, accelerometers, wind speed sensors, global positioning system monitoring, and other sensors. In some embodiments, the vehicle may include markers for infrared sensing of the structure from the ground or other observation points. In some embodiments, the structure may include on-board cameras to view the flight path, or the horizon, as desired by the control system and/or the user.

In some embodiments of the present invention, the power delivered from each generator will be joined in a system bus and then routed via electrical conductors in the tether to the ground. The power from the airborne power generation system may be routed to the ground using high voltage DC.

In some embodiments, the wind turbine driven generators may generate AC in the range of 400-5000 volts. A motor controller is used to convert the AC output to a DC output in the same range as the AC input, wherein the AC motor voltage may be the same voltage as the DC output voltage of the motor controller, which may be referred to as the motor voltage. The DC motor voltage is then converted to a high DC voltage, which is then the voltage at which power may be transferred to the ground via the tether. The high voltage DC may be referred to as the tether voltage.

In some embodiments, each motor controller for each wind turbine driven generators may have its own DC-DC converter. In some embodiments, the lower voltage DC output from each motor controller may go to one or more motor voltage busses, each of which then have one or more DC-DC converters which raise the voltage to the tether voltage. The use of multiple motor voltage busses, each of which receives input from multiple generators, and each of which in turn has utilizes multiple DC-DC converters to convert to the tether voltage, allows for redundancy of the converters per motor voltage bus such that the failure of a single DC-DC converter does not reduce the power transmission from that motor voltage bus in most if not all operating conditions. Also, using this approach, the failure of a single wind turbine driven generator, which may be one of many feeding a motor voltage bus, does not also idle DC-DC conversion capacity. As used herein, the term motor controller is used for the unit which controls the motor when the unit is used as a motor, and also controls the unit when used as a generator.

In some embodiments, the strutted frame structure is adapted for take-off from the ground using powered flight. The power may come from the ground station and be routed through the tether to the wind turbine driven generators, which then operate as motor driven propellers. Thus, the electrical power delivery components used for airborne power generation may be adapted to transmit power in both directions. The DC-DC converters may be Dual Active Bridge (DAB) DC-DC converters. The DAB converter may use an SiC JFET cascade switch, which may give an advantage to the system in the form of size and mass savings. In some embodiments, the electrical system may use a single larger DC-DC converter to convert a single motor voltage bus to the higher tether voltage.

In some embodiments, there may be an electrical control system adapted to balance the loading on the DC-DC converters, in the case of multiple DC-DC converters. The electrical control system may also control the motor controllers for each individual wind turbine driven generator, allowing for control of overall power production, for attitude control of the flying frame, and for other reasons.

The tether used to attach the airborne system to the ground will be used to transmit power as well as being a structural attachment. The tether may be wound around a drum on the ground that is used to reel in and out the tether as well as store the unused portion of the tether. In some embodiments, the main drum which is used to mechanically reel the tether in and out may have a limited number of revolutions of the tether on it, with the remainder of the tether trailing off of this main drum onto a storage drum. This may allow a rotation of the main drum to result in a more uniform amount of tether to be reeled regardless of the altitude of the flying system.

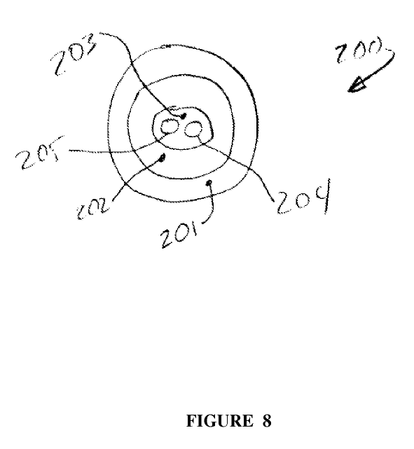

In some embodiments, as seen in FIG. 8, a tether 200 is adapted for both structural attachment and electrical conduction. An outer layer 201 may be a polymer layer, such as Hytrel. The outer layer 201 may be 0.75 mm thick. An inner layer 202 may be adapted to carry the tensile load. The inner layer 202 may be of Kevlar and may be 2.3 mm thick. An inner core 203 may be of silicone with a mylar sheath and may be 0.1 mm thick. The conductors 204, 205 may use 1.4 mm diameter copper surrounded by an insulator. In other embodiments, more conductors may be used.

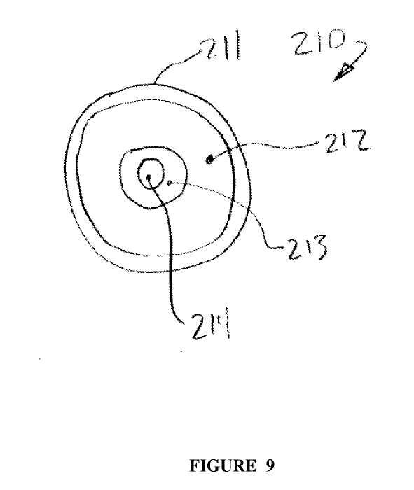

In another higher load embodiment, as seen in FIG. 9, a tether 210 may use a coaxial geometry. The outer layer 211 may be of aluminum and be 2.7 mm thick. The use of aluminum as the outer conductor, on the outside of the tether, allows for convective cooling of one of the conducting portions of the tether. Further, the use of the outer portion of the tether as a conductor allows for the wound portions of the tether on the drum to create a common conductor, which can allow for current to be put in or taken out via the drum, thus not requiring current to flow in the captured, wound portions of the tether which may otherwise overheat. The inner layer 212 may be adapted to carry the tensile load and may be Kevlar of 56.1 mm thickness. An insulator core 213 may used inside the inner layer 212. A central conductor 214 may be of aluminum and be 19 mm in diameter.

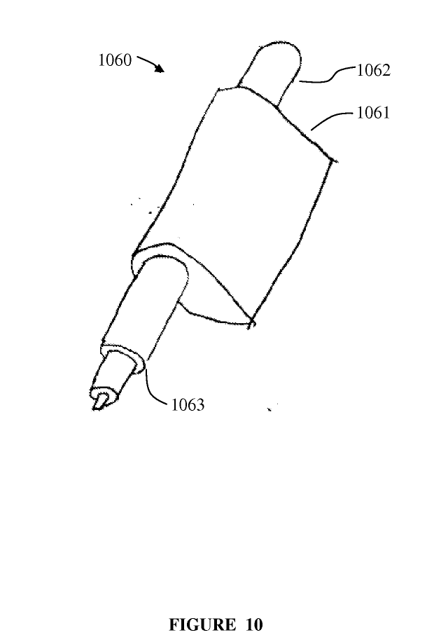

In some embodiments, as seen in FIG. 10, a tether assembly wherein a tether sheath has been placed over a tether may significantly reduce the drag of a tether. For example, using a 0.4 inch diameter tether as an illustrative example, the tether may have a certain drag while experiencing apparent winds. Using as an example a wind direction perpendicular to the tether length axis, a 0.4 inch cylindrical tether may have a drag force in a 35 mph wind of 0.15 pounds per linear foot of tether. At 65 mph, this drag may increase to 0.46 pounds per linear foot. Using a tether sheath with a 0.7 inch maximum thickness, a chord length of 2.85 inches, and with the tether centered at the 20% chord length position, the sheathed tether drag may be 0.034 pounds per linear foot at 35 mph, and 0.062 pounds per linear foot at 65 mph. The drag reduction may be in the range of 80-90%.

Another distinct advantage of the tether sheath is that in some embodiments, the tether sheath may be manufactured in relatively short lengths, and then have the longer tether inserted through it. For example, a tether may be 1000 meters long. There may be advantages to manufacturing the tether, with its structural aspect for tensile loading, and with its electrical conduction aspect, separately from the aerodynamic tether sheath. The tether sheath could thus be manufactured in shorter lengths, in the range of 3-15 meters, and be inserted over the tether after the prior manufacture of both the tether and the sheath.

Tethers and tether sheaths according to embodiments of this invention may be advantageous not only for reduced drag but also for their dynamic effects. For example, a tether sheath may allow for rotation around the tether in a manner which enhances the dynamic stability performance of the system.

In a representative example of a single plane strutted frame structure used in an airborne power generation system according to some embodiments, a 320 kW system may use 16 wind turbine driven generators. The frame structure uses five rows of airfoil segments, with the middle row 8 segments wide, the next two (upper and lower) with 7 segments, and the top and bottom row having 6 airfoil segments each. The system is designed around the nominal conditions of 12 meters/second of wind speed at 1000 meters. The system would use a cross-wind flying method resulting in a resultant wind speed of 49.2 meters/second.

A total of 44 airfoil segments would be used, each with a span of 2 meters and a chord length of 0.8 meters. 84 cross struts would be used, with a length of 1.2 meters and a chord length of 0.4 meters. The cross struts would use a symmetric airfoil shape to reduce drag.

Each of the wind turbine driven generators would be adapted to provide 20 kW while rotating at 3000 rpm using two 0.8 meter radius blades. The power generation turbine would weigh 8 kg. The strutted frame structure with its turbines would weigh 964 kg, and the tether weight would be 1480 kg, for a total airborne mass of 2444 kg.

In a representative example of a two plane strutted frame structure used in an airborne power generation system according to some embodiments, a 100 MW system may use 220 wind turbine driven generators. The frame structure uses 13 rows of airfoil segments in its front plane of airfoils, with the middle row 20 segments wide, the next two (upper and lower) with 19 segments, with one less segment per row as distance from the middle row is increased, and with the top and bottom row having 14 airfoil segments each. The frame structure uses 11 rows of airfoil segments in its rear plane of airfoils, with the middle row 19 segments wide, and one less airfoil segment per row in the upper and lower directions, with the top and bottom rows having 14 airfoil segments each.

The system is designed around the nominal conditions of 16 meters/second of wind speed at 6600 meters. The system would use a cross-wind flying method resulting in a resultant wind speed of 66.2 meters/second.

A total of 390 airfoil segments would be used, each with a span of 12 meters and a chord length of 2.2 meters. 1100 cross struts would be used, with a length of 12 meters and a chord length of 1.1 meters. The cross struts would use a symmetric airfoil shape to reduce drag. With the cross struts the same length as the airfoil segments, the cross struts would run from each end of an airfoil segment on one row to the junction between two airfoil segments of the row above or below, forming an equilateral triangle. In addition, the same cross struts would be used to connect the front plane of the frame structure to the rear plane of the frame structure, resulting in the rear plane rows being slightly above the front plane rows, traversing through the centroid to the equilateral triangle of the front row when viewed in a front perspective.

Each of the wind turbine driven generators would be adapted to provide 450 kW while rotating at 420 rpm using two 5.5 meter radius blades. The power generation turbine would weigh 188 kg. Wind turbine driven generators would be mounted into the front row of airfoils only. The strutted frame structure with its turbines would weigh 99,893 kg, and the total weight of the system including tether weight would be 375,408 kg. The tether length would be 10,158 meters, with a tether diameter of 13.62 cm.

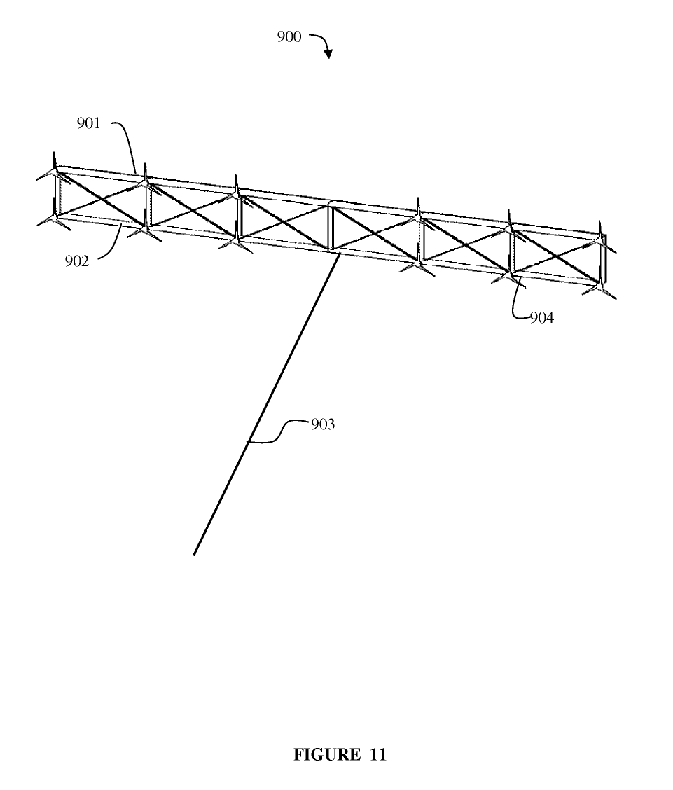

In some embodiments of the present invention, as seen in FIG. 11, an airborne power generation system 900 may have two rows of airfoils 901, 902. The system may be adapted to use a tether 903 with a nominal length of 1000 m. The system may utilize 12 turbine driven generators 904 which are mounted along the two rows of airfoils. The turbines (propellers) may have a diameter of 2.4 m. The nominal total power rating of such a system may be 1 MW. The system may be adapted for flying at 74 meters/second in an 8.5 meters/second ambient wind using a cross wind flight path such as a circular flight path.

The horizontal sections of the frame structure are airfoil elements. Power generation turbines are placed at most of the junctions of the airfoils and cross struts. In some embodiments, the power generation turbines may utilize blades which are pitch controllable. The blade pitch may be controlled with mechanisms at the hub into which the blades are attached. The blade pitch control may allow the blade pitch to be adjusted to allow for better efficiencies depending upon the apparent wind speed at the turbine, as well as limiting rotor speed in high speed winds. The blade pitch control may also allow the drag of a turbine to be altered to allow for attitude control of the strutted frame structure using differential control of the drag of turbines throughout the structure.

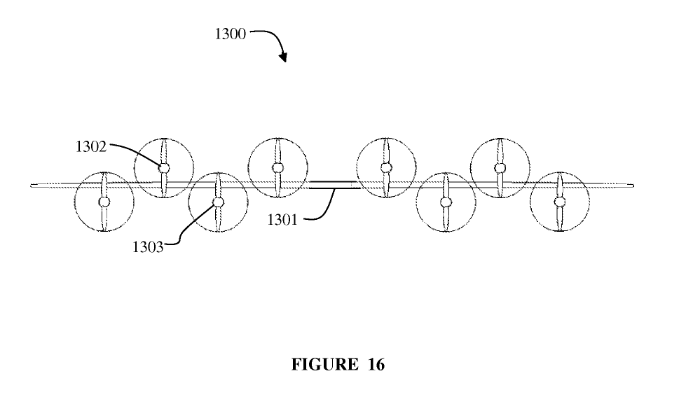

In some embodiments of the present invention, as seen in FIG. 16, a flying frame structure 1300 adapted for airborne power generation may use a single airfoil 1301. The system may use turbine driven generators 1302 above the airfoil 1301 and also generators 1303 which are below the airfoil. The spacing both above and below the airfoil enhances the control of the structure by spacing the thrust/drag elements across two dimensions.

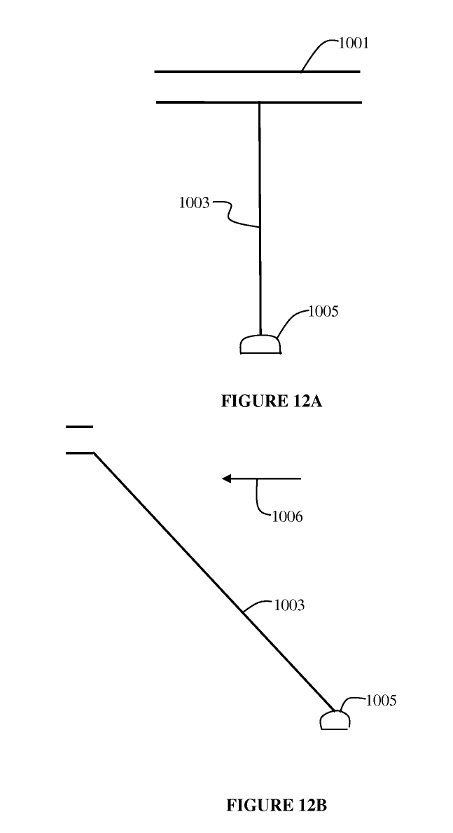

FIG. 12A illustrates a front end view of an airborne system in a relatively stationary airborne mode. FIG. 12B illustrates a side view of an airborne system in a relatively stationary airborne mode.

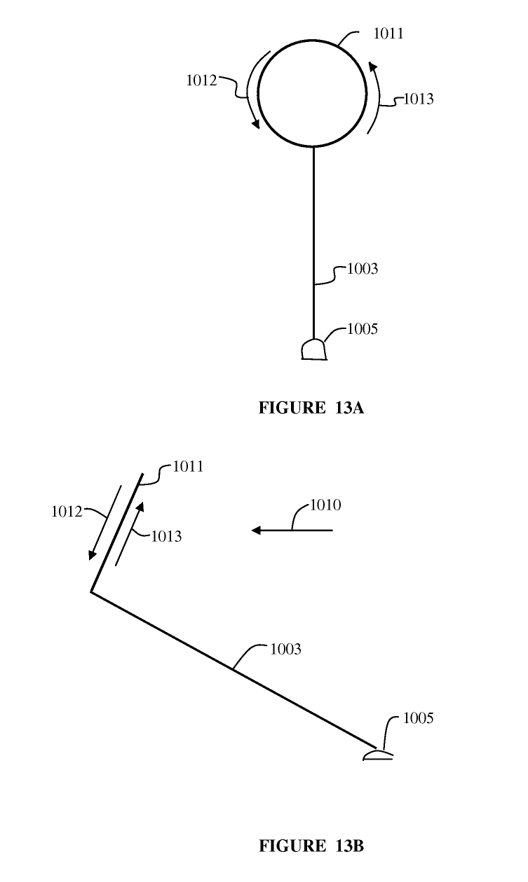

In some embodiments, the airborne power generation system may be flown in an alternate flight paradigm. Cross-wind flying paradigms allow for a higher flight speed, and a higher air flow speed into the power generating turbines. A cross-wind flying paradigm may take on a variety of shapes, such as a FIG. 8, or may be substantially circular. FIGS. 13A and 13B illustrate a front end and side view, respectively, of a circular flying paradigm. Using the power generation system of FIG. 11 as an example, on a 1000 m tether and with an 8.5 meter/second ambient wind 1010, the airborne power generation structure flies in a substantially circular flight path 1011. In such a flight path, the airborne power generation structure may achieve a nominal average flight speed of 74 meter/second of composite apparent wind speed, which is substantially higher than the ambient wind speed. The composite apparent wind speed is the resultant through the turbine from the cross-wind flying speed and the ambient wind speed.

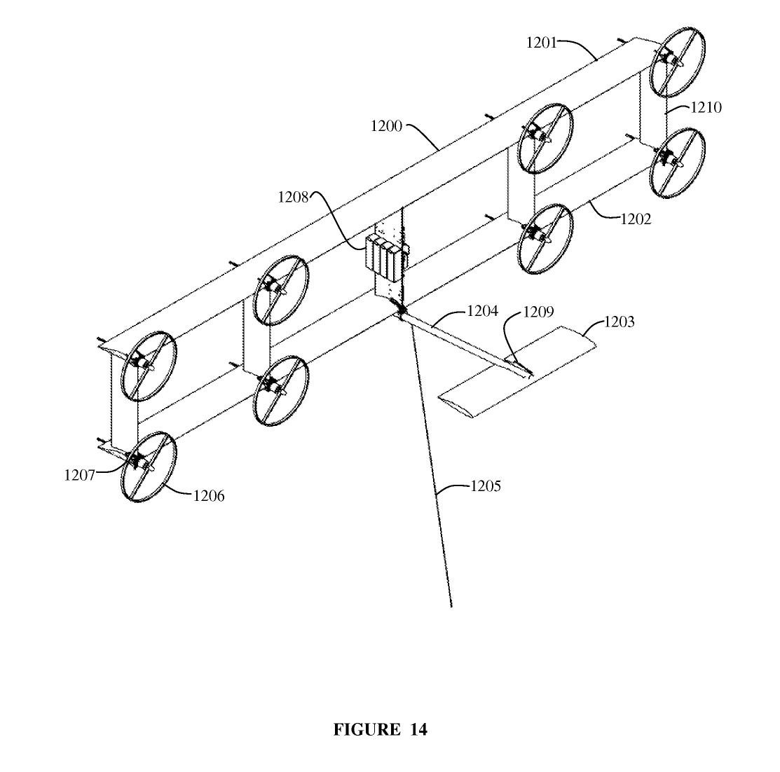

The high speeds which may be achieved during the cross-wind flight paths may be realized using vehicle pitch control which is controlled in part, or in whole, by the use of a front canard. As seen in FIG. 14, an airborne power generation vehicle 1200 includes a front canard 1203 which may be mounted forward of the main part of the vehicle on a canard boom 1204. A top airfoil 1201 and a bottom airfoil 1202 may each have four generators 1207 driven by turbines 1206. In a powered flight scenario, the turbine driven generators may be operated as motor driven propellers. In some embodiments, there may be a bank of electronics 1208.

In airborne flight scenarios, the airborne power generation vehicle 1200 may be tethered to a ground stations with a tether 1205. The tether 1205 may be a combination of a structural attachment and an electrical conduit. The front canard 1203 on the canard boom 1204 may be adjusted in pitch using a canard controlling mechanism 1203.

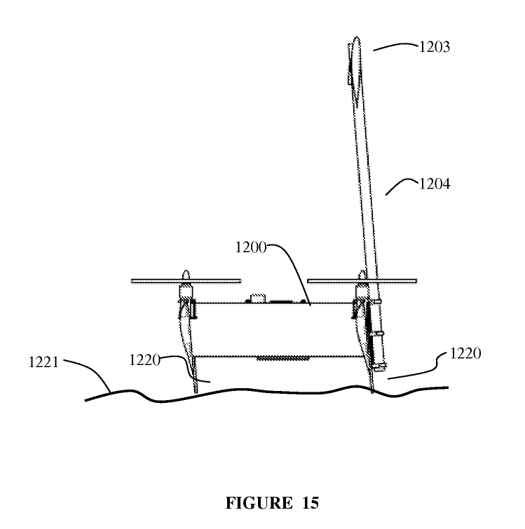

FIG. 15 illustrates a distinct advantage of an airborne power generation vehicle 1200 with a front canard 1203 with regard to vertical take-off and landing. The airborne power generation vehicle 1200 may be adapted to engage in vertical take-off and landing. The bottom of the vehicle 1200 (which is the rear in regular flight) while on the ground 1221 may reside upon struts 1220. The front canard 1203 and the canard boom 1204 are extended upwards in the take-off position. The front canard configuration blends well with the vertical take-off and landing aspects of the vehicle.

In some embodiments, the entire front canard 1203 is adapted to pivot around an axis parallel to the leading edge of the front canard. The canard controlling mechanism 1203 may pivot the front canard 1203 which in turn will cause a pitch change of the vehicle 1200. FIGS. 9A and 9B illustrate a front view and a top view, respectively, of the airborne power generation vehicle 1200 flown with a front canard 1203.

In flight, the vehicle 1200 may be controlled in pitch using the front canard, or using the front canard in conjunction with other methods described herein.

The present invention has been particularly shown and described with respect to certain preferred embodiments and specific features thereof. However, it should be noted that the above-described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims. Also, reference in the claims to an element in the singular is not intended to mean “one and only one” unless explicitly stated, but rather, “one or more”. Furthermore, the embodiments illustratively disclosed herein can be practiced without any element which is not specifically disclosed herein.

What is claimed is:

1. A system configured to capture wind energy, the system comprising:
a flying structure configured to be flown in air currents enabling the capture of wind energy;
a tether system that anchors the aircraft when it is airborne;
a power system that enables the capture and transmission of electrical energy generated by the flying structure; and
a control system enabling control of the flying structure,
wherein said flying structure comprises:
a plurality of airfoil sections arranged such that the airfoil sections are separated by a frame structure and are adapted to fly over each other when in horizontal flight, wherein each of said airfoil sections comprises a plurality of airfoil segments, said airfoil segments separated by junctions; and
a plurality of cross struts running between airfoil segments on one airfoil section and airfoil segments on higher or lower airfoil section.

2. The system of claim 1 further comprising a plurality of turbine driven generators mounted along said airfoil segments.

3. The system of claim 2 wherein said plurality of turbine driven generators are mounted at junctions between said airfoil segments.

4. The system of claim 1 wherein said plurality of airfoil sections comprises a first airfoil section comprising a plurality of identical first airfoil segments.

5. The system of claim 2 wherein said plurality of airfoil sections comprises a first airfoil section comprising a plurality of identical first airfoil segments.

6. The system of claim 4 wherein said plurality of airfoil section further comprises a second airfoil section comprising a plurality of identical first airfoil segments.

7. The system of claim 5 wherein said plurality of airfoil section further comprises a second airfoil section comprising a plurality of identical first airfoil segments.

8. The system of claim 2 wherein said plurality of turbine driven generators comprises a first plurality of identical turbine driven generators.

9. The system of claim 5 wherein said plurality of turbine driven generators comprises a first plurality of identical first turbine driven generators.

10. The system of claim 7 wherein said plurality of turbine driven generators comprises a first plurality of identical first turbine driven generators.

11. The system of claim 1 said plurality of cross struts comprises a first plurality of identical first cross struts.

12. The system of claim 2 said plurality of cross struts comprises a first plurality of identical first cross struts.

13. The system of claim 4 said plurality of cross struts comprises a first plurality of identical first cross struts.

14. The system of claim 5 said plurality of cross struts comprises a first plurality of identical first cross struts.

15. The system of claim 6 said plurality of cross struts comprises a first plurality of identical first cross struts.

16. The system of claim 7 said plurality of cross struts comprises a first plurality of identical first cross struts.

17. The system of claim 8 said plurality of cross struts comprises a first plurality of identical first cross struts.

18. A system configured to capture wind energy, the system comprising:
a flying structure configured to be flown in air currents enabling the capture of wind energy;
a tether system that anchors the aircraft when it is airborne;
a power system that enables the capture and transmission of electrical energy generated by the flying structure; and
a control system enabling control of the flying structure,
wherein said flying structure comprises:
an airfoil section; aid airfoil section comprising a plurality of airfoil segments, said airfoil segments separated by junctions.

19. The system of claim 18 further comprising a plurality of turbine driven generators mounted along said airfoil segments.

20. The system of claim 19 wherein said plurality of turbine driven generators are mounted at junctions between said airfoil segments.
